(19) United States
(12) Patent Application Publication
(10) Pub. No.: US 2003/0202736 A1
(43) Pub. Date: Oct. 30, 2003

(54) Optical switch

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/295,231

(22) Filed: Nov. 14, 2002

(30) Foreign Application Priority Data
Apr. 25, 2002 (TW) 91205682

(51) Int. Cl. G02B 6/35

(52) U.S. Cl. 385/16; 385/36

(57) ABSTRACT

An optical switch includes an input port (21) having an input fiber (211), an output port (22) having a plurality of output fibers (221), a prism assembly (23) having a plurality of prisms, a holder (25), a driving device (27) and a base (26). The input port, the output port and the driving device are mounted on the base. The holder is slidingly engaged with the base and defines a plurality of mounting holes arranged in a line, and each mounting hole accommodates a prism. As the holder is moved by the driving device, each prism moves, one at a time, into an optical path between the input and output fibers, and can deflect the light beams from the input fiber in different directions, thereby, switching the input light beams to different, predetermined output fibers.

### BACKGROUND OF THE INVENTION

1. Field of the Invention

The present invention relates to an optical switch for using in optical communication and optical network technology, and particularly to a mechanically operated optical switch with a plurality of prisms as a switching element. A copending application having the same filing date, the same title, the same applicant and the same assignee with the invention, is referenced hereto.

2. Description of Related Art

Optical signals are commonly transmitted in optical fibers, which provide efficient light channels through which optical signals can pass. Recently, optical fibers have been used in various fields, including telecommunications, where light passing through an optical fiber is used to convey either digital or analog information. Efficient switching of optical signals between individual fibers is necessary in most optical processing systems or networks to achieve the desired routing of the signals.

Various optical fiber systems, employing different methods, have been previously developed for switching optical signals between fiber cables. Among these previously developed systems, one important category is mechanical optical switches.

Mechanically operated optical switches come in two different designs: in one design, the optical components move, and in the other design, the fibers move. Factors for assessing the capability of an optical switch include low insertion loss (<1 dB), good isolation performance (>50 dB) and bandwidth capacity compatible with the fiber network.

Moving fiber switches involve the actual physical movement of one or more of the fibers to specific position to accomplish the transmission of a light beam from one fiber end to another under selected switching conditions. Moving optical component switches, on the other hand, include optical collimating lenses which expand the light beam coming from the fibers, and moving prisms or mirrors which redirect the expanded light beam to other fibers, as required by the switching process.

The moving fiber switches have a stringent tolerance requirement for the amount and direction of fiber movement. The tolerance is typically a small fraction of the fiber core diameter for two fibers to precisely align to reduce losses. The fibers themselves are quite thin and may be subject to breakage if not properly protected. On the other hand, reinforcing the fibers with stiff, protective sheaths makes the fibers less flexible, increasing the force required to manipulate each fiber into alignment. Thus, these moving fiber switches share a common problem of requiring high precision parts to obtain precise position control and low insertion loss. This results in high cost and complicated manufacture of the switches. Moreover, frequently moving fibers to and fro is apt to damage or even break the fibers.

The moving optical component switches, in contrast, have less stringent movement control tolerance requirements. The presence of collimating lenses allows relaxation of the tolerance requirements.

FIG. 8, shows a shifted optical fiber type switch as disclosed in U.S. Pat. No. 4,146,856. This optical switching device comprises an envelope 10, a pair of magnetically permeable reed arms 111, 112, three support members 121, 122, 123, and three optical fibers 131, 132, 133. The reed arms 111, 112 are mounted to opposite ends (not labeled) of the envelope 10. The reed arms 111, 112 respectively extend into the envelope 10 and overlap each other at inner ends (not shown) thereof. The support member 121 defines a bore 124, and is attached to a top of the end of the reed arm 112. The support member 122 defines a bore 125, and is attached to an inner wall of the envelope 10. The support member 123 defines a bore 126, and is mounted to the end of the reed arm 111 such that it generally opposes the support member 121. The three optical fibers 131, 132, 133 extend through the ends of the envelope 10, and are respectively secured in the bores 124, 125, 126 of the support members 121, 122, 123. When the reed arms 111, 112 are magnetized such that they have opposite polarities, they abut against each other. The optical fiber 131 is thus aligned with optical fiber 133. When the reed arms 111, 112 are magnetized such that they have the same polarity, they repel each other such that the support member 121 abuts against the inner wall. The optical fiber 131 is thus aligned with the optical fiber 132. In this way, optical transmission paths can be switched. However, a misalignment can often occur when the position of the moveable optical fiber 131 changes too frequently. Misalignment increases optical loss and reduces the quality of the transmitted light.

As illustrated in FIG. 9, U.S. Pat. No. 5,420,946 describes an optical coupling switch for coupling light beams from an input port 14 into a selected output port 16. The input fiber 141 is optically aligned with one of a plurality of output fibers 161 via a switching element 15. By rotating the reflector 152 attached to a block 151 of the switching element 15 about an axis 153, the input light beam can be reflected to a selected output fiber 161. The input fiber 141 and all the output fibers 161 are in fixed positions relative to each other.

In this mechanical switch, the plurality of output fibers 161 are separately mounted on a platform, which makes the structure of the switch complex, the size large, and the aligning process between the input fiber 141 and the plurality of output fibers 161 involved. In addition, the mechanical switch uses a plurality of GRIN lenses 162, 142 on front ends of the output fibers 161 and the input fiber 141 to collimate the light beams, which adds greatly to the cost of the mechanical switch.

For the above reasons, an improved optical switch is desired. In particularly, an optical switch is desired which has low cost, high optical efficiency and which does not require precise alignment or movement of the optical fibers themselves.

### SUMMARY OF THE INVENTION

An object of the present invention is to provide an optical switch in which the optical fibers don't move.

Yet another object of the present invention is to provide an optical switch which is low cost and small in size.

An optical switch comprises an input port having an input fiber, an output port having a plurality of output fibers, a holder holding a plurality of prisms, a driving device and a base.

Input light beams from the input fiber transmit through a first collimating lens of the input port, which collimates the dispersed input light beams to parallel light beams. The parallel light beams then pass through one predetermined prism of the plurality of prisms are refracted and redirected the parallel light beams in a predetermined direction. The refracted parallel light beams then pass through a second collimating lens of the output port, which converges the light beams into one predetermined output optical fiber. Each prism can be sequentially moved into the optical path of the light beams, between the input and output optical fibers. Each different prism refracts and redirects the light beams from the input optical fiber in a different direction, thereby switching the input light beams to different output fibers.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an optical switch according to the present invention;

FIG. 2 is a schematic, cross-sectional view taken along the line 2-2 in FIG. 1;

FIG. 3 is a schematic, cross-sectional view taken along the line 3-3 in FIG. 1;

FIG. 4 is a cross-sectional view of a multi-fiber ferrule of the optical switch of FIG. 1;

FIG. 5 is an essential optical paths diagram of the optical switch in FIG. 1 with a first prism in the optical path;

FIG. 6 is an essential optical paths diagram of the optical switch in FIG. 1 with a second prism in the optical path;

FIG. 7 is a schematic diagram of a prior art optical switch; and

FIG. 8 a perspective view of another prior art optical switch.

### DETAILED DISCLOSURE OF THE INVENTION

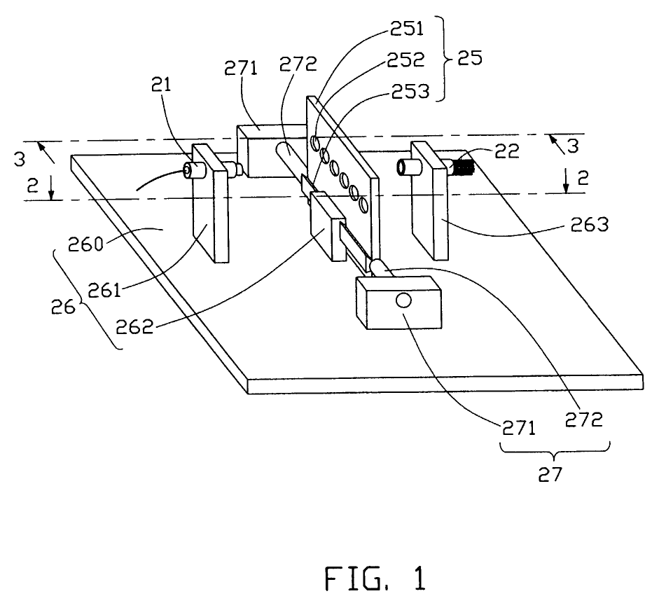

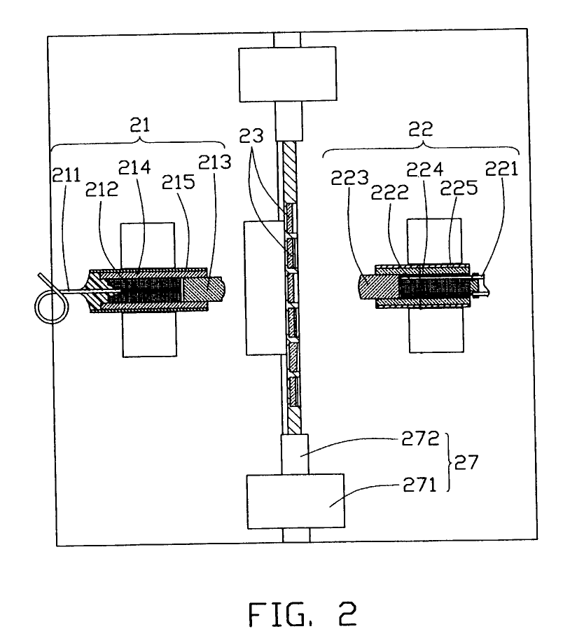

Referring to FIGS. 1 and 2, an optical switch comprises an input port 21, an output port 22, a holder 25, a prism assembly 23 held in the holder 25, a base 26 and a driving device 27.

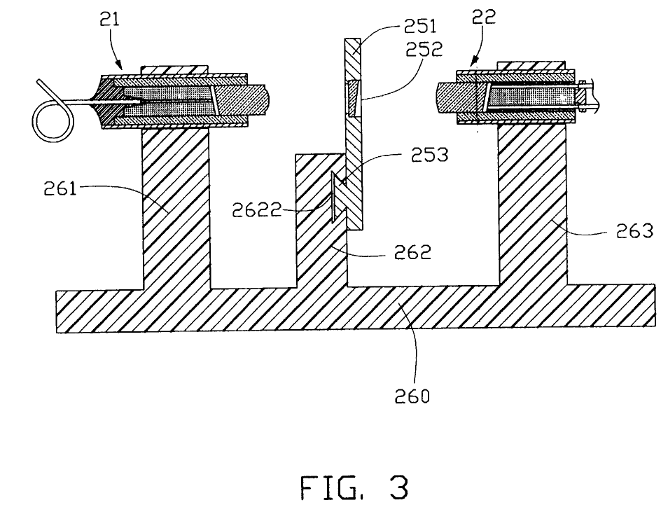

Also referring to FIG. 3, the base 26 has a substrate 260 and three upright beams 261, 262, 263 extending upwardly from the substrate 260. The upright beams 261, 263 are opposite one another for alignment of the input port 21 and the output port 22.

The holder 25 comprises a holding block 251 defining a plurality of mounting holes 252 extending therethrough, and a ridge 253 extending from one face of the holding block 251. The ridge 253 is received in a slot 2622 defined in the upright beam 262, and can slide therein. The plurality of mounting holes 252 is arranged in a line, wherein each prism of the prism assembly 23 is accommodated and fixed in a corresponding mounting hole 252 by epoxy resin. Each prism has a first planar end face (not labeled), which makes an angle with a plane defined perpendicular to an optical axis, the optical axis being coaxial with the input port 21 and output port 22. The first planar end face opposes the output port 22. A second planar end face (not labeled) of the prism is perpendicular to the optical axis, said second planar end face opposing the input port 20. The prism assembly 23 can instead be a lens assembly.

The input port 21 comprises an input fiber 211, a ferrule 212, a first collimating lens 213 aligning with the ferrule 212, and a quartz sleeve 214 receiving the first collimating lens 213 and the ferrule 212 therein. The ferrule 212 defines a through hole (not labeled), which accommodates an exposed portion of the input optical fiber 211. The input fiber 211 is fixed in the through hole with epoxy resin. The first collimating lens 213, which can be a molded lens having a single index, partially extends out of the quartz sleeve 214. The input port 21 further has a metal tube 215 surrounding the quartz sleeve 214 for protecting the input port 21.

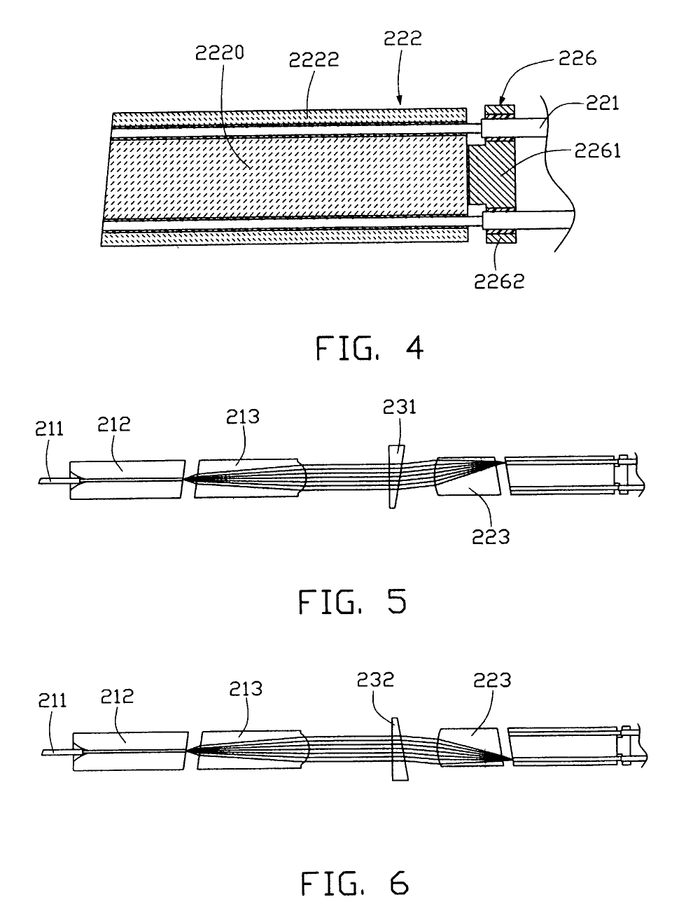

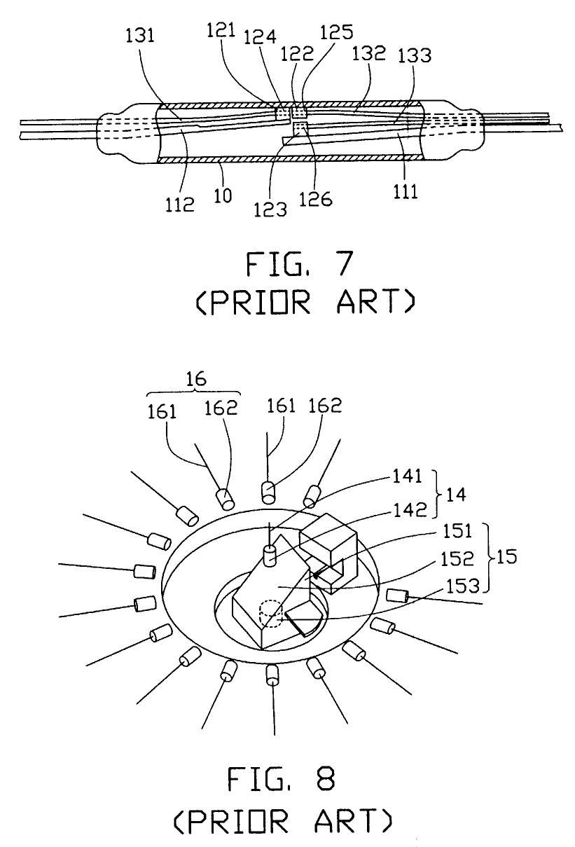

Referring to FIGS. 2 and 4, the output port 22 has a multi-fiber ferrule 222, a plurality of output fibers 221, a second collimating lens 223, a fiber holder 226 and a quartz sleeve 224. The multi-fiber ferrule 222 comprises a core 2220 and a sleeve 2222 surrounding the core 2220. A plurality of grooves (not labeled) are defined, evenly spaced apart, in an exterior surface (not labeled) of the core 2220. Each output fiber 221 has an exposed end portion which is mounted in a corresponding groove of the multi-fiber ferrule 222. The second collimating lens 223 has a single index and aligns with the output fibers 221. The fiber holder 226 comprises a ring 2262 and a support portion 2261, with an annular space (not labeled) formed therebetween to receive and fix the fibers 221 using epoxy resin. The fiber holder 226 is attached to the multi-fiber ferrule 222. The quartz sleeve 224 receives and fixes the multi-fiber ferrule 222 and the second collimating lens 223. The second collimating lens 223 is a molded lens and partially extends out of the quartz sleeve 224. The output port 22 further has a metal tube 225 surrounding the quartz sleeve 224 for protecting the output port 22.

The driving device 27 comprises two opposite supporting members 271, two driving poles 272 and an actuator (not shown). An inner end of each driving pole 272 connects with the a corresponding side of the holding block 251 of the holder 25, and an outer end of each driving pole 272 is received in a through hole (not labeled) defined in a corresponding supporting member 271. The driving device 27 can drive the holder 25 from side to side through the driving pole 272, the ridge 253 sliding in the slot 2622 of the upright beam 262.

In assembly, the input port 21, the output port 22 and the holder 25 are mounted on the upright beams 261, 263, 262, respectively. The two upright beams 261, 263 are parallel, and the input and output ports 21, 22 are aligned to be coaxial with each other. The prism assembly 23 is mounted in the holder 25. The holder 25 is connected with the driving device 27, and is positioned between the input and output ports 21, 22. The prisms of the prism assembly 23 sequentially align, one at a time, with the two input and output ports 21, 22.

FIG. 5 and FIG. 6 illustrate the operation of the optical switch. When the holder 25, (and the prism assembly 23), is in a first position, the input light beams from the input fiber 211 transmit through the first collimating lens 213, which collimates the dispersed input light beams into parallel light beams. The collimated light beams are then transmitted through a first prism 231, which refracts and redirects the parallel light beams in a predetermined direction. The refracted, parallel light beams then pass through the second collimating lens 223, which converges the light beams into one predetermined output fiber 221. When the holder 25, (and the prism assembly 23), is moved to a second position, a second prism 232 of the prism assembly 23 is aligned with the input and output ports 21, 22 and the input light beams are collimated by the first collimating lens, are transmitted as parallel beams to the second prism 232, are refracted and redirected by the second prism 232 in a second predetermined direction, and converged by the second collimating lens 223 into another, predetermined output optical fiber 221.

Advantages of the optical switch of the present invention over those of the prior art include the following. First, only optical components of the switch move; no fibers move. Second, using a ferrule to accommodate a plurality of output fibers decreases the size of the switch and lessens its cost, compare to the large size and high cost of the prior art design having separated output optical fibers with a plurality of GRIN lenses. Thus, the cost and the size of the design of the present invention are minimized.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An optical switch for switching light beams from one input fiber between a plurality of output fibers, comprising:
a first collimating lens aligning with the input fiber;
a second collimating lens aligning with the output fibers;
a prism assembly being arranged between the first and second collimating lenses comprising a plurality of prisms;
a holder defining a plurality of through holes arranged in a line for accommodating said prisms therein; and
wherein, each prism can be moved, one at a time, into an optical path between the input and output fibers, said each prism can thereby deflect the light beams coming from the input fiber in a determined different direction, thereby, switching the input light beams between different output fibers.

2. The optical switch of claim 1, further comprising a ferrule holding the input fiber and a multi-fiber ferrule holding the output fibers.

3. The optical switch as claimed in claim 2, wherein the multi-fiber ferrule comprises a core, and a plurality of grooves is defined, evenly spaced apart, in an exterior surface of the core, and each of the plurality of output fibers is mounted in a corresponding groove.

4. The optical switch as claimed in claim 3, wherein the multi-fiber ferrule further comprises a sleeve surrounding the core to stably mount the output fibers in the grooves of the multi-fiber ferrule.

5. The optical switch as claimed in claim 4, further comprising a metal tube and a quartz sleeve, the quartz sleeve surrounding and fixing the multi-fiber ferrule and the second collimating lens therein, and metal tube surrounding and fixing the quartz sleeve therein.

6. The optical switch of claim 1, wherein the first and second collimating lenses are molded lenses each having a single index.

7. The optical switch of claim 1, wherein the holder further comprises a holding block and a ridge extending from the holding block, and the plurality of through holes are defined in the holding block.

8. The optical switch of claim 7, wherein the optical switch further comprises a base with an upright beam, and the upright beam defines a slot which receives the ridge of the holder therein.

9. An optical switch for switching light beams from one input fiber between a plurality of output fibers, comprising:
a first collimating lens aligning with the input fiber;
a second collimating lens aligning with the output fibers;
a prism assembly being arranged between the first and second collimating lenses comprising a plurality of prisms;
a holder defining a plurality of through holes arranged in a line for accommodating said prisms therein; and
wherein, each prism can be linearly moved, one at a time, into an optical path between the input and output fibers, said each prism can thereby deflect the light beams coming from the input fiber in a determined different direction, thereby, switching the input light beams between different output fibers.

10. An optical switch for switching light beams from one input fiber between a plurality of output fibers, comprising:
a first collimating lens aligning with the input fiber;
a second collimating lens aligning with the output fibers;
a prism assembly being arranged between the first and second collimating lenses comprising a plurality of prisms;
a holder defining a plurality of through holes arranged in a line for accommodating said prisms therein; and
wherein, each prism can be moved, one at a time, into an optical path between the input and output fibers, said each prism can thereby deflect the light beams coming from the input fiber in a determined different direction, thereby, switching the input light beams between different output fibers; wherein
the output fiber include bared fibers supported by a core and jacketed fibers supported by a support portion axially located outside of the core.
